(19) United States
(12) Patent Application Publication
(10) Pub. No.: US 2008/0280001 A1
(43) Pub. Date: Nov. 13, 2008

(54) Natural Layer Mineral Granulates and Method For the Production Thereof

(75) Inventors: Ulrich Sohling, Freising (DE); Klaus Schurz, Munchen (DE); Hubert Simmler-Hubenthal, Moosburg (DE)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(73) Assignee: SUD-CHEMIE AG, Munchen (DE)

(21) Appl. No.: 11/908,983

(22) PCT Filed: Mar. 20, 2006
(86) PCT No.: PCT/EP2006/002473

§ 371 Date: Mar. 18, 2008

(30) Foreign Application Priority Data
Mar. 18, 2005 (DE) 10 2005 012 638.3

(51) Int. Cl. B01J 21/16; C11D 17/06; A23K 1/00

(52) U.S. Cl. 426/531; 502/80; 502/63; 510/446

(57) ABSTRACT

The invention relates to a process for producing granules and to a granule obtained by the process. In the process, a clay material is used which has a specific surface area of more than 150 m²/g, a pore volume of more than 0.45 ml/g and a cation exchange capacity of more than 15 meq/100 g.

The invention relates to a process for producing granules and to a granule which comprises a clay material.

Many liquid raw materials have to be converted to a solid form for specific applications. To this end, the liquids are applied to suitable carrier materials. For example, liquid washing composition raw materials, such as nonionic surfactants, are granulated with carrier materials such that they can be added to solid washing composition formulations such as washing powders or washing tablets. In the course of granulation, the carrier is simultaneously finished to a particular particle size during the absorption of the washing composition raw material. In addition to the sector of washing compositions, there also exists a multitude of further sectors in which liquid starting materials have to be converted to a solid form in order then to be processed further in a mixture with further solid raw materials. For instance, in the animal feed industry, a multitude of liquid raw materials are used, which are likewise applied to carriers in order then to be introduced into solid animal feed. When the liquid raw material is added directly to the animal feed, lump formation generally occurs. The feed can then no longer be handled efficiently. This relates, for example, to the production of fish feed pellets, in which fats are applied to carriers. Other applications are the conversion to animal feed of choline chloride in a 75% aqueous solution, which is applied to precipitated silica. Further applications in which liquid raw materials have to be converted to a solid form are, for example, plant extracts for pharmaceutical applications or else crop protection compositions which are spread in solid form, for example on a field.

In the conversion of liquid raw materials to a solid form, it is essential that the resulting powder retains a free-flowing consistency, such that it can, for example, be dosed without any problem. The liquid raw material must also not be released again from the carrier in the course of storage. Moreover, the carrier should have a maximum absorption capacity, since the carrier material is usually inert even for the intended use of the liquid raw material. In the case of too low an absorption capacity, the weight and the volume of the solid powder for a given amount of liquid raw material rise. As a result, for example, the transport or storage costs also rise.

For the absorption of liquid raw materials to date, owing to their high absorption capacity, especially synthetic silicas have been used. These synthetic silicas are produced from alkali metal silicate solutions by the wet method, preferably sodium waterglass. Addition of acid precipitates amorphous silica, which has a very high specific surface area and a very high absorption capacity. After filtering, washing and drying, the precipitated product consists of from 86 to 88% SiO₂ and from 10 to 12% water. The water is physically bound both in the molecular assembly and at the surface of the silica. Moreover, the silica still comprises residues of the salts formed in the reaction and minor metal oxide impurities. Variation of the most important precipitation parameters, such as precipitation temperature, pH, electrolyte concentration and precipitation time allows the preparation of silicas with different surface properties. It is possible to provide silicas in the range of specific surface areas from about 25 to 700 m²/g.

The silica suspension obtained in the precipitation is transferred to filter presses, the solids content of the filtercake being between about 15 and 20%. The drying is effected by different processes, which are frequently followed by grinding and classifying steps. It is possible to use either hydrophilic or hydrophobic silicas, and hydrophobic silicas may simultaneously serve as defoamers.

The silicas used principally as support materials preferably have an average particle diameter of from about 1 to 100 μm. In most cases, precipitated silicas with high specific surface area and high adsorption capacity, which is characterized by the oil number or the dibutyl phthalate number (DBP number) to DIN 5360 I, are preferred. Such precipitated silicas may absorb from approx. 50 to 75% by weight of liquid raw materials and enable them to be sent to their particular applications in concentrated solid form.

In addition to silica, other carrier materials are also used for absorbing liquid raw materials. For example, WO 99/32591 describes a particulate washing and cleaning composition which comprises from 40 to 80% by weight of zeolite and from 20 to 60% by weight of one or more alkoxidized C₈-C₁₈-alcohols and alkylpolyglycosides. Based on the amount of the zeolite, it contains at least 25% by weight of one or more zeolites of the faujasite type.

Clay materials are used to date only in exceptional cases for the production of granules which serve as carriers for a substance of value. A significant field of use of clay materials has to date been in the application as bleaching earth for lightening the color of fats and oils. In this context, however, it is desired that the bleaching earths used have a minimum absorption capacity for the fats and oils to be bleached in order thus to suppress losses which are caused by oil or fat residues remaining in the bleaching earth after the bleaching. Moreover, these bleaching earths have a relatively high acidity, i.e. a suspension of such materials in water has a pH which is clearly in the acidic range, i.e. at values below about pH 3. These bleaching earths are either produced by extracting natural clay materials with strong acids or by modifying natural clay materials with an acid.

DE 19 49 590 C2 describes cleaning and/or refining agents for oily substances, which are obtained by extracting a clay containing at least 50% by weight of montmorillonite with acid. To this end, the clay and the acid are mixed in a ratio of 1 part by weight of clay to from 0.3 to 2.5 parts by weight of acid. Small solid particles are formed from this mixture, which are in turn extracted with aqueous acid at elevated temperature. After the extraction, the product has a particle diameter of from 0.1 to 5 mm, a specific surface area of at least 120 m²/g and a pore volume of at least 0.7 ml/g. The pore volume corresponds to the difference between the reciprocal apparent density and the reciprocal true density of the acid-treated products. The total pore volume is preferably formed by small pores which have a diameter of from 0.02 to 10 μm. The acid-extracted clay material preferably has a proportion of the pore volume formed by small pores in the total pore volume in the range from 35 to 75%. A high proportion of small pores is characteristic of clay materials extracted with strong acid.

The precipitated silicas described above have a very high purity and a very high whiteness. However, they are very expensive owing to the specific production process. For many uses, there is therefore a need for inexpensive carrier materials with a high liquid absorption capacity.

It is therefore an object of the invention to provide a process for producing granules with which it is possible in an inexpensive manner to produce granules which can absorb large amounts of liquid substances of value.

This object is achieved by a process having the features of claim 1. Advantageous developments of the process form the subject matter of the dependent claims.

It has been found that the clay material used in the process according to the invention can be used to bind high amounts of liquid raw materials and convert them to a free-flowing form. The absorption capacity for liquids may be up to 61% by weight and thus nearly achieve the values of precipitated silica. The clay material can be obtained from natural sources and would, in the simplest case, merely have to be freed of hard impurities, such as quartz or feldspar, and possibly ground. The clay material can therefore be provided inexpensively. The absorption capacity of clay minerals for liquids, as used, for example, for bleaching oils, is usually a maximum of about 40% by weight. As a result of the selection of specific clay materials, however, a significantly higher absorption capacity for liquids can be achieved. Without wishing to be bound to this theory, the inventors suspect that the high liquid absorption capacity of the clay materials used in the process according to the invention is based on the specific pore size distribution. The use of specific clay materials thus constitutes an inexpensive alternative to the synthetic precipitated silicas, especially for applications in which a high whiteness is not important.

Specifically, the process according to the invention for producing granules is performed in such a way that
a solid granulation mixture is provided, which comprises at least a proportion of a clay material which has
   a specific surface area of more than 150 m²/g;
   a pore volume of more than 0.45 ml/g; and
   a cation exchange capacity of more than 15 meq/100 g, preferably more than 40 meq/100 g,
the solid granulation mixture is contacted with a liquid granulating agent; and
the mixture of the solid granulation mixture and the liquid granulating agent is shaped to a granule.

The specific surface area of the clay material is preferably more than 180 m²/g, especially more than 200 m²/g.

The pore volume is measured by the BJH process and corresponds to the cumulative pore volume for pores having a diameter between 1.7 and 300 nm. The clay material preferably has a pore volume of more than 0.5 ml/g.

The cation exchange capacity of the clay material used in the process according to the invention is preferably more than 25 meq/100 g, especially preferably more than 40 meq/100 g.

The solid granulation mixture comprises, as an essential constituent, a clay material which has the above-specified physical parameters. The solid granulation mixture may consist only of the clay material. However, it is also possible that the granulation mixture, as well as the clay material, also comprises further solid constituents. Such constituents are, for example, precipitated silica, silica gels, aluminum silicates, for example zeolites, pulverulent sodium silicates or other clay minerals, for example bentonites or kaolins.

The solid granulation mixture is present in powder form, and the mean particle size (DT 50), determined by laser granulometry, is preferably in the range from 2 to 100 μm, preferably from 5 to 80 μm. In order to achieve a good stability of the granules produced from the inventive granulation mixture and a high absorption capacity for substances of value, the granulation mixture is preferably provided in the form of a fine powder. The mean particle size (DT 50) is preferably selected at less than 70 μm, preferably less than 50 μm, especially preferably less than 30 μm.

The granulation mixture preferably has a dry screen residue on a screen with a mesh size of 63 μm of at most 4%, preferably at most 2%.

A suspension of the clay material in water more preferably has a neutral to weakly alkaline pH. The acidity of the clay material is preferably within a range of from 6.5 to 9.5, preferably from pH 7 to 9.0, especially preferably within a range from 7.5 to 8.5. A process for determining the acidity is specified in the examples. As a result of the neutral character of the clay material, it is also possible to incorporate sensitive substances into a granule. As a result of the low acidity, acid-catalyzed decomposition reactions are suppressed, such that the shelf life of the granules or of the substance of value present therein can be increased.

The solid granulation mixture is contacted with a liquid granulating agent. In the simplest case, this may be water.

However, it is also possible in principle to use any liquids provided that they can solidify the solid granulation mixture to a granule.

The mixture of the solid granulation mixture and the liquid granulating agent is shaped to a granule. The granulation is performed in customary granulation apparatus. It is possible to employ all granulation processes known per se. For example, the solid granulation mixture can be moved in a drum and the liquid granulating agent can be sprayed on as a fine mist. However, it is also possible to drip the liquid granulating agent onto the solid granulation mixture while it is moved in a mixer. Finally, it is also possible to mix the solid granulation mixture and the liquid granulating agent and then to move them in a mixer such that a granule forms.

The finished granule can then also be dried in order to set the moisture content to a desired value. Equally, it is also possible to comminute and/or screen the granule in order to establish a desired particle size.

The size of the particles of the granule is not subject to any restrictions per se and is selected according to the intended use. For washing composition applications, preference is given to using granules which have a particle size in the range from 0.2 to 2 mm. For animal feed additives, usually smaller particle sizes are used, which form fine powders or microgranules.

Particular preference is given to using clay materials which, based on the anhydrous clay material (atro), have an SiO₂ content of more than 65% by weight. Also preferred are clay materials whose aluminum content, based on the anhydrous clay material and calculated as Al₂O₃, is less than 11% by weight.

The clay material preferably has a water content of less than 15% by weight, preferably less than 5% by weight, especially preferably 2-4% by weight.

The inventors assume that the clay materials used with particular preference in the process according to the invention can be described as a kind of blend of amorphous silicon dioxide, for example of the naturally occurring phase opal A, with a sheet silicate, for example a dioctahedral smectite. The dioctahedral smectite incorporated may, for example, be a montmorillonite, a nontronite or a hectorite. The smectite layers are incorporated in a fixed manner into the porous amorphous silica gel structure, and are present principally in the form of very thin platelets and may even be completely delaminated. This would explain the X-ray reflections which can be observed only weakly, if at all, for these clay materials. The clay materials used with preference in the process are essentially X-ray-amorphous. Reflections typical for sheet silicates, for example a hump at from 20 to 30° and the 060 indifference, are only weak for these clay materials. The weakness of the 00L reflections indicates especially that the platelets of the sheet silicate are present in almost completely delaminated form in the porous structure. On average, the sheet silicate is present as a sheet stack of only a few lamellae. Caused by the incorporated sheet silicate, these porous structures still have a significant cation exchange capacity, as is normally only typical of pure smectites.

The clay materials used in the process according to the invention are preferably obtained from natural sources. However, it is also possible to use synthetic clay materials which have the above-described properties. Such clay materials can be produced, for example, from waterglass and bentonite. The clay materials used in the process according to the invention are preferably not obtained by acid leaching from clay minerals.

Particular preference is given to using clay materials which have only a low crystallinity, i.e. cannot be assigned to the class of the sheet silicates per se. The low crystallinity can be found, for example, by X-ray diffractometry. The particularly preferred clay materials are substantially X-ray-amorphous, i.e. they exhibit, in the X-ray diffractogram, essentially no sharp signals or only very low proportions of sharp signals. They therefore preferably do not belong to the class of the attapulgites or smectites.

The clay material used in the process according to the invention preferably exhibits virtually no swellability in water. The sediment volume is determined essentially by the sediment density in water. Little or no swelling takes place. As a result, the sediment volume remains virtually constant as a function of time. Moreover, it is significantly lower than that of sheet minerals. The swelling volume of calcium bentonites is typically about 10 ml/2 g, that of sodium bentonites up to 60 ml/2 g. The clay material preferably has a sediment volume in water of less than 15 ml/2 g, preferably less than 10 ml/2 g, especially preferably less than 8 ml/2 g. Even in the case of prolonged storage in water or other liquids, no significant change, if any at all, in the sediment volume is observed. The sediment volume when the clay material is left to stand in water at room temperature over three days is preferably less than 15 ml/2 g, preferentially less than 10 ml/2 g, especially preferably less than 8 ml/2 g. Room temperature is understood to mean a temperature in the range from about 15 to 25° C., especially about 20° C. Sodium bentonites or potassium bentonites, unlike the clay materials used in the process according to the invention, exhibit a very high swelling volume in water.

The clay material used in the process according to the invention preferably has a particular pore radius distribution. The pore volume is determined essentially by pores which have a diameter of more than 14 nm. More preferably, the clay materials used in the process according to the invention have such a pore radius distribution that at least 40% of the total pore volume (determined by the BJH method, see below) is formed by pores which have a pore diameter of more than 14 nm. Preferably more than 50% and especially preferably more than 60% of the total pore volume is formed by pores which have a diameter of more than 14 nm. The total pore volume of these clay materials is, as already explained, more than 0.45 ml/g. The pore radius distribution and the total pore volume are determined by nitrogen porosimetry (DIN 66131) and evaluation of the adsorption isotherms by the BJH method (see below).

As already explained above, the granulation mixture, as well as the above-described clay material, may also comprise further constituents, for example carrier materials or granulation assistants. The proportion of the clay material in the solid granulation mixture is preferably at least 10% by weight, preferably at least 20% by weight, preferably at least 40% by weight, especially preferably at least 60% by weight. Since the clay material used in the process according to the invention can be provided relatively inexpensively, a high proportion of the clay material in the granulation mixture gives rise to cost advantages. However, naturally occurring clay minerals are usually not pure white, but may contain impurities, for example metal oxides which lead to a slight brown color of the clay mineral.

Especially for applications in which high whiteness is desired, for example in washing compositions, the solid granulation mixture may also comprise a proportion of silica. Silica is pure white, especially when it has been produced synthetically, and therefore contributes to the lightening of the color of the granules. Moreover, synthetic silica has a high liquid-bearing capacity, such that the absorption capacity of the granules produced is not worsened.

The proportion of the silica can in principle be selected as desired. When a virtually white appearance of the granules is required, the proportion of the preferably synthetic silica is preferably at least 20% by weight, preferably at least 30% by weight, especially preferably at least 50% by weight. For economic reasons, the proportion of the silica is preferably at most 90% by weight.

As already explained, in the simplest case, water can be used as a liquid granulating agent. For a practical use, however, the granulating agent preferably comprises a substance of value. A substance of value is understood to mean a liquid substance which is to be converted to a solid, free-flowing form by the process according to the invention. In the selection of the substances of value, no limits are set per se. The process according to the invention is suitable for solidifying virtually all liquid raw materials or substances of value. Such substances of value may, for example, be formic acid, fat concentrates, rubber assistants, plant extracts, for example hops extract, molasses, perfume oils or fragrances, crop protection compositions, liquid vitamins, for example vitamin E acetate, or else a multitude of other liquid substances of value.

As a result of the inventive use of the clay material with the physical properties explained above, it is possible to obtain a granule which contains a very high amount of liquid. The proportion of the substance of value which is present in the liquid granulating agent is therefore preferably selected such that it corresponds to at least 40% by weight, preferably at least 50% by weight, of the solid granulation mixture. The liquid granulating agent may, as well as the substance of value, also comprise an evaporable liquid as an assistant, for example water or alcohol, in order, for example, to be able to set the viscosity of the liquid granulating agent at a suitable level. The liquid used as an assistant may be evaporated during the granulation, for example by blowing-in heated air.

Particular preference is given to using the process according to the invention for the production of washing composition components. In this application, the substance of value is accordingly preferably a surfactant. It is possible to use all surfactants which are customary in washing composition production. It is possible, for example, to use anionic surfactants, and also cationic or else nonionic surfactants, for example ethoxylated fatty alcohols. Since these granules are used in washing compositions, the size of the granule particles is preferably selected within a range from 0.1 to 5 mm, preferably from 0.2 to 2 mm.

A further preferred field of use for the process according to the invention is the production of animal feed components. These animal feed components are usually processed into larger animal feed particles, for example into pellets. In order to enable good further processing, the particle size of the granules is therefore selected at a somewhat lower level than for washing composition granules. When used as animal feeds, the granules preferably have a particle size in the region of less than 0.5 mm, preferably from 0.1 to 0.4 mm. The size of the granule particles can be adjusted, for example, by a controlled process regime during the contacting with water or the liquid granulating agent. The particle size can equally be adjusted by screening off. Preferably, however, the granulation process is conducted such that the desired particle size is already obtained in the granulation.

The granules are produced by means of a mixing process. According to the desired properties of the granule, different mixers are used. The granulation can be performed either continuously or batchwise. The hardness of the granule can be established through the intensity of the shear forces which act on the mixture of solid granulation mixture and liquid granulating agent in the course of the mixing process. To produce soft powders, so-called drum mixers, V blenders or tumblers are used. Harder granules are obtained through the use of conical mixers, plowshare mixers or spiral mixers. Examples of plowshare mixers are Lödige® FKM mixers and Drais Turbo-Mix™ mixers. One example of a spiral mixer is the Nauta® mixer from Hokosawa, Japan. Hard granules are obtained, for example, with Lödige® CB mixers, Drais Corimix® K-TT mixers, Ballestra® Kettemix® units and Schugi® granulators. These mixers are preferably used for the production of granules for washing composition applications.

In addition to the processes described, the granules may, however, also be produced by extrusion and roll contacting with subsequent comminution.

The granules obtained by the process according to the invention have a high content of liquid substance of value and a comparatively low proportion of adsorbent or clay material. The invention therefore also provides a granule which comprises at least one clay material which has:
a specific surface area of more than 150 m²/g;
a pore volume of more than 0.45 ml/g; and
a cation exchange capacity of more than 15 meq/100 g.

The specific surface area of the clay material is preferably more than 180 m²/g, especially preferably more than 200 m²/g. The pore volume is preferably more than 50 ml/g. The cation exchange capacity of the clay material is preferably more than 25 meq/100 g, especially preferably more than 40 meq/100 g.

The inventive granule can be produced inexpensively and is suitable especially for fields of use which do not require a high whiteness.

The proportion of the clay material in the granule is preferably more than 20% by weight, preferably more than 30% by weight.

The granule preferably comprises at least one substance of value. Examples of substances of value have already been described above. In principle, the selection of the substance of value is not subject to any restrictions. It is possible in principle for any substances of value to be present in the granule and thus for it to be provided in a solid, free-flowing form.

The proportion of the substance of value in the granule is preferably at least 40% by weight, especially preferably at least 50% by weight. In particularly preferred embodiments, the proportion of the substance of value is up to 61% by weight.

The granule is particularly suitable as a component in washing compositions or for use in animal feed. The substance of value is then correspondingly selected from the group of surfactants or animal feed additives. Suitable animal feed additives are, for example, fats, choline and vitamins.

When the granule is to have a high whiteness, it preferably comprises a proportion of silica. The proportion of silica in the granule is preferably at least 10% by weight, especially preferably at least 20% by weight. In order to improve the free flow of the inventive granules, they can finally be powdered with the above-described clay material. When a particularly high whiteness of the granule is required, it is also possible to perform a final powdering with, for example, precipitated silica.

In principle, the above-described clay material can also be used for a powdering for other applications, provided that no high whiteness is required. In these processes, it can replace precipitated silica or zeolites as a powdering agent.

A further aspect of the invention consists in the use of the above-described granule for absorption of substance of value.

The invention will be explained in detail hereinafter with reference to examples.

### Characterization of Samples

For the characterization of the granules, the following processes were used:

### Surface/Pore Volume:

The specific surface area was determined to DIN 66131 on a fully automatic Mikromeretix ASAP 2010 nitrogen porosimeter. The pore volume was determined using the DJH method (E. P. Barrett, L. G. Joyner, P. P. Haienda, J. Am. Chem. Soc. 73 (1951) 373). Pore volumes of particular pore size ranges are determined by adding up incremental pore volumes, which are obtained from the evaluation of the adsorption isotherms according to BJH. The total pore volume by the BJH method is based on pores having a diameter of from 2 to 130 nm.

### Water Content:

The water content of the products at 105° C. was determined using method DIN/ISO-787/2.

### Silicate Analysis:

### (a) Sample Digestion

This analysis is based on the total digestion of the raw clay or of the corresponding product. After the solids have been dissolved, the individual components are analyzed and quantified with conventional specific analysis methods, for example ICB.

For the sample digestion, approx. 10 g of the sample to be analyzed are ground finely and dried to constant weight at 105° C. in a drying cabinet for 2-3 hours. Approx. 1.4 g of the dried sample are introduced into a platinum crucible and the sample weight is determined to a precision of 0.001 g. Thereafter, the sample is mixed in the platinum crucible with from 4 to 6 times the weight of a mixture of sodium carbonate and potassium:carbonate (1:1). The mixture is placed with the platinum crucible into a Simon-Müller oven and melted at 800-850° C. for 2-3 hours. The platinum crucible containing the melt is removed from the oven with platinum tongs and left to stand for cooling. The cooled melt is rinsed into a casserole with a little distilled water and admixed cautiously with concentrated hydrochloric acid. Once the gas evolution has ended, the solution is concentrated by evaporation to dryness. The residue is absorbed once again in 20 ml of conc. hydrochloric acid and again concentrated by evaporation to dryness. The concentration by evaporation with hydrochloric acid is repeated once more. The residue is moistened with approx. 5-10 ml of hydrochloric acid (12%), admixed with approx. 100 ml of dist. water and heated. Insoluble SiO₂ is filtered off, and the residue is washed three times with hot hydrochloric acid (12%) and then with hot water (dist.) until the filtrate water is chloride-free.

### (b) Silicate Determination

The SiO₂ is reduced to ash with the filter and weighed.

### (c) Determination of Aluminum, Iron, Calcium and Magnesium

The filtrate collected in the silicate determination is transferred to a 500 ml standard flask and made up to the calibration mark with distilled water. From this solution, by means of FAAS, aluminum, iron, calcium and magnesium determination are then carried out.

### (d) Determination of Potassium, Sodium and Lithium

500 mg of the dried sample are weighed precisely to 0.1 mg in a platinum dish. Thereafter, the sample is moistened with approx. 1-2 ml of dist. water and 4 drops of concentrated sulfuric acid are added. Thereafter, the mixture is concentrated by evaporation to dryness in a sand bath three times with approx. 10-20 ml of conc. HF. Finally, the mixture is moistened with H₂SO₄ and fumed to dryness on the oven plate. After brief heating of the platinum dish, approx. 40 ml of dist. water and 5 ml of hydrochloric acid (18%) are added and the mixture is boiled. The resulting solution is transferred to a 250 ml standard flask and made up to the calibration mark with dist. water. From this solution, the sodium, potassium and lithium content is determined by means of EAS.

### Ignition Loss:

In a heat-treated weighed porcelain crucible with a lid, approx. 1 g of dried sample is weighed in precisely to 0.1 mg and heated at 1000° C. in a muffle furnace for 2 h. Thereafter, the crucible is cooled in a desiccator and weighed.

### Cation Exchange Capacity:

To determine the cation exchange capacity, 5 g of the sample are screened through a 63 μm screen, and the clay material to be analyzed is then dried at 110° C. over a period of 2 hours. Thereafter, exactly 2 g of the dried material are weighed in an Erlenmeyer flask with a ground-glass joint and admixed with 100 ml of 2N NH₄Cl. The suspension is boiled under reflux for one hour. After standing at room temperature for 16 hours, the mixture is filtered through a membrane suction filter, and the filtercake is washed with dist. water until it is substantially free of ions (approx. 800 ml). The demonstration of freedom of the washing water from NH₄⁺ ions can be conducted with Nessler's reagent. The filtercake is dried at 110° C. for two hours and the NH₄ content in the clay material is determined by Kjeldahl nitrogen determination (CHN analyzer from Leco) according to the manufacturer's instructions. The cation exchange capacity is calculated from the amount of NH₄ absorbed in the clay material and determined. The proportion and the type of the exchanged metal ions in the filtrate is determined by ECP spectroscopy.

### X-Ray Diffractometry:

The X-ray images were recorded on a high-resolution powder diffractometer from Philips (X′-Pert-MPD (PW3040)), which was equipped with a CO anode.

### Determination of the Sediment Volume

A graduated 100 ml measuring cylinder is filled with 100 ml of distilled water or of an aqueous solution of 1% soda and 2% trisodium polyphosphate. 2 g of the substance to be analyzed are introduced onto the surface of the water with a spatula slowly and in portions, in each case from about 0.1 to 0.2 g. After an added portion has sunk, the next portion is added. Once the 2 g of substance have been added and have sunk to the bottom of the measuring cylinder, the cylinder is left to stand at room temperature for one hour. Subsequently, the height of the swollen substance in ml/2 g is read off on the graduation of the measuring cylinder. For the determination of the sediment volume after being left to stand for 3 days, the mixture is sealed with Parafilm® and left to stand at room temperature without shaking for 3 days. The sediment volume is then read off on the graduation of the measuring cylinder.

### Determination of the Dry Screen Residue

About 50 g of the air-dry mineral to be analyzed are weighed on a screen of mesh size 45 μm. The screen is attached to a vacuum cleaner which sucks out all fractions which are finer than the screen through the screen via a suction slit which rotates below the screen bottom. The screen is covered with a plastic lid and the vacuum cleaner is switched on. After 5 minutes, the vacuum cleaner is switched off and the amount of the relatively coarse fractions remaining on the screen is determined by difference weighing.

### Determination of the Dissolution Rates of Granules

The dissolution rate of the granules is investigated by a process as described in WO 99/32591.

Granules are first screened with a screen of mesh size 200 μm. 8 g of the screened material are added to one liter of water which has been heated to 30° C. and has 210 German hardness. A paddle stirrer is used to stir at 800 revolutions/min for 90 sec. The remaining residue of the granule is screened off with a screen of mesh size 0.2 mm and then screened to constant weight at 40° C. and then dried to constant weight at 40° C. The residue is weighed and the solubility is determined as the difference from the amount of granule weighed in.

### Determination of the Whiteness

The reference parameter for the whiteness measurement is the reflectance of BaSO₄. By comparison with BaSO₄, the reflectance of other substances is reported in percent. The measurement of the reflection factor R 457 at a center wavelength of 457 mm is performed by means of a Datacolor Elrepho 2000 unit. With the aid of a suitable add-on program, the Hunter color coordinates L, a and b can be determined, where L expresses the whiteness.

10 g of granule are screened through a screen of mesh size 45 μm. The residue remaining on the screen is ground with a laboratory mill and screened again. This procedure is repeated until no residue remains on the screen. The powder screened off is dried at 130° C. in a forced-air drier for 13 minutes and then cooled in a desiccator.

The cooled powder is either analyzed directly or pressed in a Zeiss tableting press and analyzed immediately on the Elrepho unit (Datacolor Elrepho 2000; Program R 457, possibly with Hunter color plate).

### Determination of the Methylene Blue Value

The methylene blue value is a measure of the internal surface area of clay materials.

### a) Preparation of a Tetrasodium Diphosphate Solution

5.41 g of tetrasodium diphosphate are weighed accurately to 0.001 g into a 1000 ml standard flask and made up to the calibration mark with dist. water while shaking.

### b) Preparation of a 0.5% Methylene Blue Solution

In a 2000 ml beaker, 125 g of methylene blue are dissolved in approx. 1500 ml of dist. water. The solution is decanted off and made up to 25 l with dist. water.

0.5 g of moist test bentonite with known internal surface area are weighed precisely to 0.001 g in an Erlenmeyer flask. 50 ml of tetrasodium diphosphate solution are added and the mixture is heated to boiling for 5 minutes. After cooling to room temperature, 10 ml of 0.5 molar H₂SO₄ are added, and from 80 to 95% of the expected final consumption of methylene blue solution are added. A glass rod is used to absorb a drop of the suspension and place it onto a filter paper. This forms a blue-black spot with a colorless corona. Further methylene blue solution is now added in portions of 1 ml and the spotting test is repeated. The addition proceeds until the corona becomes pale blue in color, i.e. the amount of methylene blue added is no longer absorbed by the test bentonite.

### c) Testing of Clay Materials

The testing of the clay material is performed in the same way as for the test bentonite. The internal surface area of the clay material can be calculated from the consumed amount of methylene blue solution.

### Determination of the Acidity of the Clay Material

A 5% by weight suspension of the clay material to be analyzed in distilled water is prepared. The pH is determined at room temperature (20.0° C.) with a calibrated glass electrode.

### EXAMPLE 1

### Characterization of Clay Material A

A clay material A suitable for the process according to the invention (obtainable from: Sud-Chemie AG, Moosburg, Germany, raw clay ref. No.: 03051) was analyzed for its physicochemical properties. The results achieved here are compiled in table 1a.

TABLE 1
Physicochemical analysis of clay material A

| | | |
|---|---|---|
| Specific surface area | m²/g | 219 |
| Pore volume | ml/g | 0.881 |
| Cation exchange capacity | meq/100 g | 52 |
| Dry screen residue | 45 μm (% by wt.) | 3 |
| Dry screen residue | 60 μm (% by wt.) | 1.7 |
| Sediment volume (1 h) | ml/2 g | 5.5 |
| Sediment volume (3 d) | ml/2 g | 6.5 |
| Acidity | pH | 8.3 |
| Silicate analysis: | | |
| SiO₂ | % by wt. | 70.6 |
| Fe₂O₃ | % by wt. | 2.8 |
| Al₂O₃ | % by wt. | 9.8 |
| CaO | % by wt. | 1.4 |
| MgO | % by wt. | 4.1 |
| Na₂O | % by wt. | 0.26 |
| K₂O | % by wt. | 1.5 |
| TiO₂ | % by wt. | 0.25 |
| Ignition loss (2 h at 1000° C.) | % by wt. | 7.9 |
| Total | % by wt. | 98.6 |

### EXAMPLE 2

### Performance of the Granulation

To produce the granules described in the examples which follow, unless stated otherwise, an Eirich R02E intensive mixer was used. In this case, the low setting (level 1) for the rotational speed of the pan and the maximum rotational speed for the agitator were selected. The granulation parameters were, unless stated otherwise, selected hereinafter in each case such that more than 50% of the granules were present in a particle size range of from 0.4 to 1.6 mm. The mean particle size can be modified by varying the granulation parameters.

In order to reduce the tack of the agglomerates, they were coated with lime or zeolite if appropriate. To this end, the granule was transferred to a plastic bag, the inorganic powder was added and the contents of the bag were shaken for about 2 min. For larger batches, the coating of the granule was performed in the Eirich mixer. To this end, after the granulation, the inorganic powder was added and the granule was mixed at 50% of the maximum agitator rotational speed for from 20 to 30 sec.

### EXAMPLE 3

### Production of Washing Composition Granules Using Nonionic Surfactants

400 g of the clay material A characterized in example 1 were granulated with Dehydrol® LT 7 (Cognis AG, Düsseldorf, Germany) in the manner described in example 2.

As a comparative example, the same granulation was performed with a precipitated silica (Sipernat® 22 Degussa AG, Germany)

The surfactant content was calculated in each case from the amount of surfactant added.

The granules were coated in each case with 10% zeolite A (Zeolon® P4A, MAL alumina, Hungary) and the granule of size fraction 0.4-1.6 mm was removed by screening-off.

The dissolution rate and the whiteness were determined in each case. The results are reported in table 2.

TABLE 2
Dissolution rate and whiteness of granules

| | | | Hunter L |
|---|---|---|---|
| | Surfactant | | whiteness |
| | content of the | | (coating: |
| Carrier | granules | Solubility | 10% |
| material | [% by wt.] | [%] | zeolite A) |
| Clay material | 56 | 56 | 56 |
| A; table I | | | |
| Sipernat 22 | 60 ± 3 | | 78 |
| (comparative | | | |
| example) | | | |
| Laundrosil DGA | 35-37 | 26 | n.d. |
| (comparative | | | |
| example) | | | |

### EXAMPLE 4

### Granulation of Choline Chloride Solution

Solid 99% choline chloride (Sigma Aldrich, Taufkirchen, Germany) was used to prepare a 70% aqueous solution. Such a solution is used industrially in animal feed production.

In the manner specified in example 2, 235 g of choline chloride, as a 70% aqueous solution, were granulated with 300 g of the clay material A characterized in table 1. The granulation was stopped as soon as a fine granule was obtained.

For comparison, a precipitated silica (Sipernat® 22, Degussa AG) and a sodium bentonite (Laundrosil DGA, Süd-Chemie AG, Germany) were used analogously. The results are compiled in table 3.

TABLE 3
Granulation of choline chloride solution

| | Achievable content of 75% |
|---|---|
| Carrier material | choline chloride solution |
| Sipernat ® 22 | 65.9% |
| Clay material A example 1 | 43.9% |
| Laundrosil ® DGA | 29% |

As table 3 shows, the precipitated silica absorbs approx. 66% choline chloride solution. A customary sodium bentonite, in contrast, absorbs only 29% by weight of the choline chloride solution. The clay material A characterized in table 1 absorbs 43.9% by weight of choline chloride. Compared to a conventional bentonite, the clay material A thus absorbs significantly higher amounts of liquid.

### EXAMPLE 5

### Determination of the Methylene Blue Value

The methylene blue value was determined for the clay material A characterized in example 1 and for further bentonites. The results are reported together with further parameters in table 4.

TABLE 4
Characterization of carrier materials

| | Clay | | | |
|---|---|---|---|---|
| Material | material A | Comparative | Comparative | |
| property | example 1 | bentonite 1 | bentonite 2 | Sipernat ® 22 |
| Methylene | 83 | 327 | 368 | |
| blue value | | | | |
| [mg/g] | | | | |
| Cation | 52 | 72 | 90 | |
| exchange | | | | |
| capacity | | | | |
| [mg/g] | | | | |
| Sediment | <10 | 18 | 55 | 10.5 |
| volume | (virtually | | | |
| in water | does not | | | |
| [ml/2 g] | swell) | | | |
| Specific | 200 | 51.2 | 15.8 | 102¹⁾ |
| BET surface | | | | 169³⁾ |
| area [m²/g] | | | | |
| BJH pore | 0.882 | 0.14 | 0.08 | 0.985 |
| volume²⁾ | | | | |
| [ml/g] | | | | |
| Max. | 56 | 36 | 38 | 60-62 |
| surfactant | | | | |
| content in | | | | |
| granulation | | | | |
| with | | | | |
| alcohol | | | | |
| ethoxylate | | | | |
| 7 EO | | | | |

¹⁾Manufacturer data
²⁾Cumulative pore volume of pores with diameters between 17 and 300 nm
³⁾In-house measurement

### EXAMPLE 6

### Carrier Capacity for Nonionic Surfactants

Table 6 shows typical nonionic surfactant contents of granules which have been produced with different carrier materials.

TABLE 5
Nonionic surfactant contents of carrier materials

| | Typical nonionic | |
|---|---|---|
| | surfactant content | |
| | of the granules thus | |
| Carrier (powder) | produced | Citation |
| Sodium sulfate | 20% | In-house tests |
| STPP | 23% | /1/ |
| (sodium tripoly- | | |
| phosphate), low | | |
| density | | |
| Soda, low density | 25% | /1/ |
| Zeolite A | 25% | /1/ |
| Zeolite MAP | 30% | In-house tests |
| Bentonite | 33-38% | In-house tests |
| Precipitated silica | | |
| Sipernat ® 22 | 60-64% | In-house tests/ |
| (Degussa) | | manufacturer |
| | | information |
| Neosyl ® GP°° (Ineos | 60-65% | In-house tests/ |
| Silica) | | manufacturer |
| | | information |
| Sipernat ® 50°° | 70-75 | In-house tests/ |
| (Degussa) | | manufacturer |
| | | information |

/1/ K. H. Raney, Surfactant Requirements for Compact Powder Detergents in Powdered Detergents, M. Showell ed., Marcel Dekker 1998, pp 263.

### EXAMPLE 7

### Granulation of Vitamin E

In the manner described in example 2, vitamin E acetate (vitamin E acetate oily feed BASF AG, Ludwigshafen, Germany) were granulated with 400 g of the carrier materials listed in table 6. In addition to the clay material A characterized in table 1, precipitated silica (Sipernat® 22, Degussa AG) and a mixture of silica and the clay material A characterized in example 1 was performed. The maximum liquid carrying capacity of the individual powders is listed in the following table 6:

TABLE 6
Carrying capacity for vitamin E acetate

| | | Maximum vitamin E |
|---|---|---|
| | Amount of | acetate content of the |
| Carrier (powder) | vitamin E added | granules thus produced |
| 400 g of clay material A | 500 | 55% |
| according to ex. 1 | | |
| 300 g of Sipernat ® 22 | 646 | 68.5% |
| 400 g of Sipernat ® 22:clay | 680 | 63% |
| material A ex. 1 | | |
| (3:1) | | |

The clay material A characterized in example 1 has a very high carrier capacity for vitamin E. The clay material can also be used in a mixture with precipitated silica. For instance, a powder mixture in which 25% of the precipitated silica has been replaced by the clay material exhibits almost the same liquid carrying capacity for vitamin E acetate as precipitated silica.

### EXAMPLE 8

### Whiteness of Mixtures of Silica and Clay Material

For the determination of the whiteness, the clay material A characterized in example 1 was used to press a tablet which was analyzed. For the comparison to precipitated silica, the unpressed material was used in each case, since precipitated silica cannot be pressed to tablets.

The values determined are listed in table 7.

TABLE 7
Whiteness of carrier materials

| Sample/sample preparation | Hunter L value |
|---|---|
| Clay material A ex. 1 compressed | 86.5 |
| Not compressed: | |
| Clay material A ex. 1 | 81 |
| Sipernat ® 22 | 93 |
| Sipernat ® 22/clay material ex. 1 (9:1) | 88 |
| Sipernat ® 22/clay material ex. 1 (8:2) | 86 |
| Sipernat ® 22/clay material ex. 1 (7:3) | 84 |
| Sipernat ® 22/clay material ex. 1 (6:4) | 83.4 |
| Sipernat ® 22/clay material ex. 1 (5:5) | 83 |

Both the clay material A characterized in example 1 and mixtures of the clay material with precipitated silica have not only a high liquid carrying capacity but also a high whiteness.

### EXAMPLE 9

### Granulation of Ether Sulfate

As an example of an anionic surfactant, the surfactant Texapon® N70 (Cognis AG, Düsseldorf, Germany) was used. This contains 70% ether sulfate and 30% water.

800 g of the clay material A characterized in example 1 were granulated with in each case 945 g of Texapon® N70. This corresponds to a content of 52% ether sulfate in the finished granule. Granule with a bulk density of 740 g/l is obtained, which is very soluble in water (solubility 98%).

For comparison, the ether sulfate was granulated with the bentonite LAUNDROSIL® DGA (Süd-Chemie AG, Germany). With this bentonite as the carrier, it was only possible to produce granules with a content of ether sulfate of 24.6%.

### EXAMPLE 10

### Granulation of Soya Lecithin

Under the conditions specified in example 2, soya lecithin, as an example of an animal feed application, was granulated with different carrier materials. The carrier material used was the clay material A characterized in example 1 and precipitated silica (Sipernat® 22, Degussa AG). The soya lecithin used was technical soya lecithin from Berg+Schmidt GmbH & Co. KG, An der Alster 81, 20099 Hamburg.

The granulation parameters were adjusted so as to obtain a fine granule with a maximum soya lecithin content which is free-flowing and is of comparable consistency to corresponding Bergafit® 50 and Bergafit® 60 granules available on the market from the same manufacturer, which contain 50% and 60% lecithin respectively. The carrier capacities are reported in table 8.

TABLE 8
Granulation of soya lecithin

| Carrier material | Lecithin applied (g) | Lecithin content (%) |
|---|---|---|
| Sipernat ® 22 (400 g) | 600 | 60 |
| Clay material ex. 1 | 610 | 61 |
| (400 g) | | |

The results show that the clay material A characterized in example 1, in the granulation of soya lecithin, can completely replace precipitated silica as the carrier material.

### EXAMPLE 11

### Granule Production with Predried Clay Material

1 kg of the clay material A characterized in example 1 was dried to a water content of 3% by weight in a forced-air oven at 60-90° C.

300 g of the dried clay material A were granulated in the manner described above using 450 g of Dehydrol® LT7 or 400 g of choline chloride (70% in water) as the liquid granulating agent. It was possible to achieve a surfactant absorption of 60% by weight with Dehydrol® LT7 and an absorption of 57% with choline chloride. As a result of the drying, it was thus possible once again to significantly increase the absorption capacity of choline chloride in particular. The absorption capacity of the clay material A characterized in table 1 for choline chloride achieves virtually the absorption capacity of precipitated silica (Sipernat® 22).

### EXAMPLE 12

### Metal Leaching in Tartaric Acid

2.5 g of the clay material A characterized in example 1 (air-dried) are weighed in a 250 ml standard flask which is made up to the calibration mark with 1% tartaric acid solution. The standard flask is left to stand at room temperature for 24 hours and then the flask contents are filtered through a fluted filter. In the filtrate, the values reported in table 9 are determined by means of AAS. For comparison, the limits according to German wine legislation are also included.

TABLE 9
Metal leaching in tartaric acid

| | In tartaric acid | Limit |
|---|---|---|
| As (ppm) | 0.9 | 2 |
| Pb (ppm) | 3 | 20 |
| Ca (%) | 1.20 | 0.8 |
| Fe (%) | 0.03 | 0.2 |
| Mg (%) | 0.13 | 0.5 |
| Na (%) | 0.05 | 0.5 |
| Cd (ppm) | 0.2 | — |
| Hg (ppm) | <0.1 | — |

The data show very low metal leaching of the clay material. In particular, the clay material comprises only very small amounts of leachable heavy metals.

### EXAMPLE 13

### Characterization of Clay Material B

A further clay material which is suitable for the performance of the process according to the invention was analyzed for its chemical composition and its physical properties. The values are reported in table 10.

TABLE 10
Physicochemical analysis of clay material B

| | | |
|---|---|---|
| BET surface area | m²/g | 294 |
| Cumulative BJH pore | cm³/g | 0.53 |
| volume, 1.7-300 nm | | |
| Mean particle size D₅₀ | μm | 13 |
| from Malvern measurements | | |
| Cation exchange capacity | meq/100 g | 55 |
| Acidity | pH | 8.2 |
| Analysis: | | |
| SiO₂ | % by wt. | 57.8 |
| Fe₂O₃ | % by wt. | 3.9 |
| Al₂O₃ | % by wt. | 11.9 |
| CaO | % by wt. | 3.9 |
| MgO | % by wt. | 9.7 |
| Na₂O | % by wt. | 0.67 |
| K₂O | % by wt. | 1.7 |
| TiO₂ | % by wt. | 0.42 |
| Ignition loss (2 h 1000° C.) | % by wt. | 8.8 |
| Total | % by wt. | 98.79 |

### EXAMPLE 14

### Granulation of Choline Chloride Solution

Analogously to example 4, the clay material B characterized in table 10 was granulated with choline chloride solution (75% solution in water). The clay material B exhibits an absorption capacity of 49% for the aqueous choline chloride solution.

1. A process for producing granules, comprising
providing a solid granulation mixture comprising a clay material which has
a specific surface area of more than 150 m²/g;
a pore volume of more than 0.5 ml/g, determined by the BJH method for pores with a diameter between 1.7 and 300 nm;
a cation exchange capacity of more than 15 meq/100 g, and
an acidity in the range of pH 6.5 to 9.5, determined with a 5% by weight suspension of the clay material in distilled water;
contacting the solid granulation mixture is contacted with a liquid granulating agent; and
shaping the mixture of the solid granulation mixture and the liquid granulating agent to form granules.

2. The process as claimed in claim 1, wherein the clay material, based on an anhydrous clay material (atro), has an SiO₂ content of more than 65% by weight.

3. The process as claimed in claim 1, wherein the clay material has a sediment volume in water, after being left to stand at room temperature for 1 hour, of less than 15 ml/2 g.

4. The process as claimed in claim 1, wherein at least 40% of the pore volume of the clay material is provided by pores which have a pore diameter of at least 14 nm.

5. The process as claimed in claim 1, wherein the proportion of the clay material in the solid granulation mixture is at least 20% by weight.

6. The process as claimed in claim 1, wherein the solid granulation mixture has a proportion of further comprises silica.

7. The process as claimed in claim 6, wherein the silica comprises at least 20% by weight of the solid granulation mixture.

8. The process as claimed in one claim 1, wherein the liquid granulating agent comprises a substance of value.

9. The process as claimed in claim 8, wherein the substance of value comprises at least 50% by weight of the solid granulation mixture.

10. The process as claimed in claim 8, wherein the substance of value comprises a surfactant or a liquid washing composition raw material.

11. The process as claimed in claim 8, wherein the substance of value comprises an animal feed component.

12. The process as claimed in claim 1, wherein the granules are produced under low-shear conditions.

13. (canceled)

14. A granule which comprises at least one clay material which has:
a specific surface area of 150 m²/g;
a pore volume determined by the BJH method for pores with a diameter between 1.7 and 300 nm of more than 0.5 ml/g;
a cation exchange capacity of more than 15 meq/100 g; and
an acidity in the range of pH 6.5 to 9.5, determined with a 5% by weight suspension of the clay material in distilled water.

15. The granule as claimed in claim 14, wherein the proportion of the clay material is greater than 20% by weight.

16. The granule as claimed in claim 14, which further comprises a substance of value.

17. The granule as claimed in claim 16, wherein the substance of value comprises at least 40% by weight thereof.

18. The granule as claimed in claim 16, wherein the substance of value is selected from the group consisting of surfactants, silicones, animal feed additives and mixtures thereof.

19. The granule as claimed in claim 14 further comprising silica.

20. The granule as claimed in claim 19, wherein the silica comprises at least 20% by weight of the granule.

21. The granule as claimed in claim 14 further comprising a coating composed of the clay material.

22. (canceled)

23. A process for absorbing a substance of value comprising combining the substance of value with the granule of claim 14.
